(19) United States
(12) Patent Application Publication
(10) Pub. No.: US 2026/0192766 A1
(43) Pub. Date: Jul. 9, 2026

(54) GRILLE GUARDS AND RELATED DEVICES, SYSTEMS, AND METHODS

(71) Applicant: Holt Sales and Service, LLC, Des Moines, IA (US)

(72) Inventor: Jeremy Drever, Ankeny, IA (US)

(73) Assignee: Holt Sales and Service, LLC, Des Moines, IA (US)

(21) Appl. No.: 19/445,212

(22) Filed: Jan. 9, 2026

Related U.S. Application Data
(60) Provisional application No. 63/743,549, filed on Jan. 9, 2025.
(60) Provisional application No. 63/808,803, filed on May 20, 2025.
(60) Provisional application No. 63/884,257, filed on Sep. 18, 2025.
(60) Provisional application No. 63/891,061, filed on Sep. 30, 2025.

(51) Int. Cl. B60R 19/52

(52) U.S. Cl. CPC B60R 19/52

(57) ABSTRACT

A grille guard assembly for vehicles that integrates front underrun mitigation, steer tire protection, and serviceability. A tubular guard frame mounts to tow hooks via a mounting/latching system and is positioned forward of the bumper while remaining outside collision-mitigation sensor encroachment zones. Underrun protection is provided by a lower cross member, plate-steel gusseting, and transfer members that distribute head-on and angled impact loads laterally and into vehicle structure, with optional wraparound wings and a front end protection bar shielding sensors and lamps. Configurations include variable height coverage, enhanced tire protection, and quick-release, pivotable access with lift assistance. High-tensile steel construction with corrosion-resistant coatings and optional aerodynamic elements may be included.

### CROSS-REFERENCE TO RELATED APPLICATION(S)

This application claims the benefit under 35 U.S.C. § 119(e) to U.S. Provisional Application 63/891,061, filed Sep. 30, 2025, and entitled Improvements To Quick Release Grill Guard and Associated Systems and Methods, U.S. Provisional Application 63/884,257, filed Sep. 18, 2025, and entitled Aerodynamic Improvements to Quick Release Grill Guard and Associated Systems and Methods, U.S. Provisional Application 63/808,803, filed May 20, 2025, and entitled Grille Guards, and U.S. Provisional Application 63/743,549, filed Jan. 9, 2025, and each of which are hereby incorporated herein by reference in its entirety for all purposes.

### TECHNICAL FIELD

The disclosure relates to grille guards, and the devices, systems and methods for protecting the grills of semis, tractor trailers, trucks and other vehicles.

### BACKGROUND

The disclosure relates to vehicle grille guards, such as those disclosed in U.S. Pat. Nos. 11,230,241 and 9,114,771 and U.S. patent application Ser. No. 19/182,309, which are incorporated herein by reference in their entirety.

Trucks, such as semi-trucks and tractor trailers are ubiquitous on the roads at all hours of day and night and are integral to the world's over-the-road transportation and hauling of goods. These trucks (which include, but are not limited to, semis and tractor trailers) are expensive, and require significant investment.

Such trucks are typically fitted with a grille at the front to allow for air intake and engine cooling. In many implementations, these grilles have aesthetic properties as well as functional ones. However, with the number of deer and other hazards that are present on the roads, collisions that damage these grilles can lead to significant repair costs. Considering the continual increase in the price of fuel and other aspects of modern globalization, it is crucial for companies employing such methods of transport to keep their overall costs low. As such, there is a need in the art for a relatively inexpensive and effective way to protect these grilles.

### BRIEF SUMMARY

In Example 1, an apparatus comprising a grille guard assembly configured for installation on a front end of a vehicle, the grille guard assembly comprising a frame having a plurality of tubular crossbars and at least one aerodynamic feature affixed to or integrated with at least one of the tubular crossbars, wherein the aerodynamic feature is shaped to direct airflow in a desired direction so as to reduce aerodynamic drag associated with the grille guard assembly during vehicle operation.

Example 2 relates to the apparatus of any of Examples 1 and 3-8, wherein the aerodynamic feature comprises a fairing or airflow diverter having a generally triangular or fin-shaped profile with sides defining a central opening, the sides including a top side and a bottom side contoured to direct airflow in the desired direction.

Example 3 relates to the apparatus of any of Examples 1-2 and 4-8, wherein the aerodynamic feature is a modular component configured to be affixed to an existing grille guard via an adhesive, snap-fit interface, or fasteners.

Example 4 relates to the apparatus of any of Examples 1-3 and 5-8, wherein the aerodynamic feature is integrated into a tubular crossbar such that an internal side of the feature is coextensive with an interior of the tubular crossbar.

Example 5 relates to the apparatus of any of Examples 1-4 and 6-8, wherein curvature of exterior surfaces of the aerodynamic feature is selected to direct airflow upward at an upper crossbar and downward at a lower crossbar to reduce drag on the grille guard assembly.

Example 6 relates to the apparatus of any of Examples 1-5 and 7-8, further comprising a quick-release latching system pivotably mounting the grille guard assembly to the vehicle.

Example 7 relates to the apparatus of any of Examples 1-6 and 8, wherein the frame comprises high-tensile steel tubular members coated with a corrosion-resistant polyvinyl chloride coating.

Example 8 relates to the apparatus of any of Examples 1-7, further comprising a front end protection bar extending over forward vehicle components including collision mitigation sensors and lamps.

In Example 9, a front underrun protection system configured as a bolt-on assembly mountable to a vehicle via one or more brackets, the system comprising a tubular guard frame comprising at least a lower crossbar, gusseting positioned to resist compression, and transfer members arranged to transfer impact energy laterally into the gusseting.

Example 10 relates to the device of any of Examples 9 and 11-13, wherein the gusseting comprises welded plate gussets arranged behind the lower crossbar.

Example 11 relates to the device of any of Examples 9-10 and 12-13, wherein the tubular frame is arranged in multiple selectable height configurations.

Example 12 relates to the device of any of Examples 9-11 and 13, wherein the frame and gusseting are configured to distribute head-on and angled impact loads into the one or more brackets and the vehicle in a controlled manner while remaining forward of a bumper-mounted collision mitigation sensor and outside of a sensor encroachment zone.

Example 13 relates to the device of any of Examples 9-12, further comprising a front end protection bar integrated with the lower crossbar and gusseting.

In Example 14, a vehicle front-end aerodynamic sealing system comprising a plate arranged to close a gap between a grille guard and a front bumper of a vehicle, the plate being contoured to the front end of the vehicle and configured to separate airflow above and below a lower crossbar of the grille guard in order to reduce turbulence behind the grille guard during vehicle operation.

Example 15 relates to the system of any of Examples 14 and 16-18, wherein the plate comprises brackets configured to affix the plate to the grille guard using fasteners.

Example 16 relates to the system of any of Examples 14-15 and 17-18, wherein the plate includes a gasket along a first side contoured to the vehicle front end to seal against the vehicle.

Example 17 relates to the system of any of Examples 14-16 and 18, wherein the plate is modular and comprises multiple pieces that are joinable by fasteners or welding.

Example 18 relates to the system of any of Examples 14-17, further comprising wings affixed to the grille guard and arranged to nest adjacent to the plate in an upright position to fill a gap between the grille guard and the vehicle while providing clearance for folding movement of the grille guard.

In Example 19, a grille guard assembly for a vehicle, comprising a guard frame comprising a plurality of tubular members, a mounting and latching system configured to couple the guard frame to the vehicle, and a front underrun mitigation structure integrated with the guard frame and comprising a lower cross member, gusseting, and at least one transfer member arranged to route impact loads into the mounting and latching system and laterally across the guard frame.

Example 20 relates to the grille guard assembly of any of Examples 19 and 21-29, wherein the mounting and latching system comprises a pair of bracket members adapted to engage tow hooks of the vehicle.

Example 21 relates to the grille guard assembly of any of Examples 19-20 and 22-29, wherein the gusseting comprises plate steel gusset plates welded to the tubular members.

Example 22 relates to the grille guard assembly of any of Examples 19-21 and 23-29, wherein the at least one transfer member is located rearward of the lower cross member and is oriented to dissipate impact energy laterally into the gusseting and toward the mounting and latching system.

Example 23 relates to the grille guard assembly of any of Examples 19-22 and 24-29, further comprising a front end protection bar extending across a forward region of the vehicle to overlie at least one of a collision mitigation sensor, a fog lamp, or another forward component.

Example 24 relates to the grille guard assembly of any of Examples 19-23 and 25-29, wherein the guard frame includes wings that wrap around lateral portions of the vehicle front end and include support wraps and gusseting.

Example 25 relates to the grille guard assembly of any of Examples 19-24 and 26-29, wherein the guard frame is positioned forward of the vehicle bumper while remaining outside a sensor encroachment zone of a radar- or camera-based collision mitigation system located in or proximate the bumper.

Example 26 relates to the grille guard assembly of any of Examples 19-25 and 27-29, wherein the guard frame geometry defines clearance envelopes and positional tolerances that avoid obstruction, interference, or false triggering of the collision mitigation system across production and installation variation.

Example 27 relates to the grille guard assembly of any of Examples 19-26 and 28-29, wherein the tubular members comprise high-tensile steel with a corrosion-resistant coating.

Example 28 relates to the grille guard assembly of any of Examples 19-27 and 29, further comprising a steer-tire protection system integrated with the front underrun mitigation structure and including forwardly positioned tubular members and rearward gusseting behind the lower cross member to resist incursions into a steer-tire envelope during head-on and angled impacts.

Example 29 relates to the grille guard assembly of any of Examples 19-28, further comprising one or more of aerodynamic fairings, shelves, or sealing plates arranged to manage airflow around and through the tubular members.

While multiple embodiments are disclosed, still other embodiments of the disclosure will become apparent to those skilled in the art from the following detailed description, which shows and describes illustrative embodiments of the invention. As will be realized, the disclosure is capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1 is a cross-sectional side view of a guard, according to one implementation.

FIG. 2 is a perspective view of a guard, according to one implementation.

FIG. 3 is a rear, perspective view of guard, according to one implementation.

FIG. 4 is a side view of a guard mounted on a vehicle, according to one implementation.

FIG. 5 is a front, perspective view of a guard mounted on a vehicle, according to one implementation.

FIG. 6 is a front, perspective view of a guard, according to one implementation.

FIG. 7 is a rear, perspective view of a guard, according to one implementation.

FIG. 8 is a rear, perspective view of a guard, according to one implementation.

FIG. 9 is a perspective view of a plate, according to one implementation.

FIG. 10 is an exploded, perspective view of a plate, according to one implementation.

FIG. 11 is a rear, perspective view of a guard, according to one implementation.

FIG. 12 is a front view of a guard, according to one implementation.

FIG. 13 is a front view of a guard, according to one implementation.

FIG. 14 is a rear view of a guard, according to one implementation.

FIG. 15 is a rear view of a guard, according to one implementation.

FIG. 16 is a bottom, perspective view of a guard, according to one implementation.

FIG. 17 is a close up view of wings and gusseting on a guard, according to one implementation.

FIG. 18 is a close up view of transfer members on a guard, according to one implementation.

FIG. 19 is a diagram showing a first testing set up.

FIG. 20 is a graph showing force versus displacement response of FUPD with impactor for the first testing set up.

FIG. 21 is a diagram showing a second testing set up.

FIG. 22 is a graph showing force versus displacement response of FUPD with impactor for the second testing set up.

FIG. 23 is a diagram showing a third testing set up.

FIG. 24 is a graph showing force versus displacement response of FUPD with impactor for the third testing set up.

FIG. 25 is an exploded, front, perspective view of a modular guard, according to one implementation.

FIG. 26 is a side view of modular guard, according to one implementation.

FIG. 27 is a front, perspective view of a modular guard, according to one implementation.

FIG. 28 is a front view of a modular guard, according to one implementation.

FIG. 29 is a top view of a modular guard, according to one implementation.

### DETAILED DESCRIPTION

Exemplary embodiments and implementations of the disclosed apparatus, systems, and methods are herein described with references to the accompanying illustrations. It is to be understood that other embodiments and implementations may be utilized and structural and functional changes may be made without departing from the respective scope of the disclosure. As such, the instant description is presented by way of illustration only and should not limit in any way the various alternatives and modifications that may be made to the illustrated embodiments and implementations and still be within the spirit and scope of the disclosure.

Further, while many of the discussed implementations relate to use of the disclosed technology on pivoting, or quick release grille guards, it is of course possible and contemplated to use the teachings of the present disclosure to any of a large number of accessories, such as aftermarket grille guards and other products that can be mounted to the front end of a vehicle that may create wind resistance. It would be further understood that the various guards, assemblies, and aerodynamic features may be used in connection with a variety of vehicle types including cars, trucks, SUVs, semi-trucks, tractor-trailers, and the like as would be understood.

While references are made to the “grille guard” and “vehicle” throughout, this designation is made for brevity and in no way to reduce the scope of the various embodiments and implementations of the instant disclosure. The disclosure relates to improving grille guards, and the devices, systems and methods for protecting the grilles of semis, tractor trailers, trucks, and other vehicles.

As discussed herein, it is a one object of the disclosed apparatus, systems, and methods (collectively, the “grille guard”) to provide a protective covering for the grille of a semi, tractor trailer, truck or other automobile (“vehicle”) which provides maximum aerodynamic efficiency and, optionally, remains easy to pivot away from the vehicle.

Exemplary implementations of the quick release grille guard comprise an aerodynamic grille guard assembly and a bracket. The grille guard assembly further comprises a latching system which is configured to allow the easy adjustment of the grille guard in “open” and “closed” positions about a hinge, as has been previously described, such as in the incorporated references.

In various implementations, the grille guard is curved to closely surround the front of the vehicle and prevent damage to the vehicle and/or components thereof.

In various implementations, the grille guard has a metal frame with a coating, for example a steel frame and a PVC coating, to prevent natural wear and corrosion on the metal frame. Optionally, the PVC coating is a ⅛″ coating, resistant to UV light, cracking, peeling, and flaking. Additionally, the PVC coating may have self-healing properties, allowing for returning to shape after impacts.

In various implementations, the metal frame is high-tensile steel, such as 8 gauge high-tensile steel. Other materials such as metals, alloys, and synthetic polymers and coatings are of course possible in the construction of the frame and guard, as would be readily appreciated by those of skill in the art.

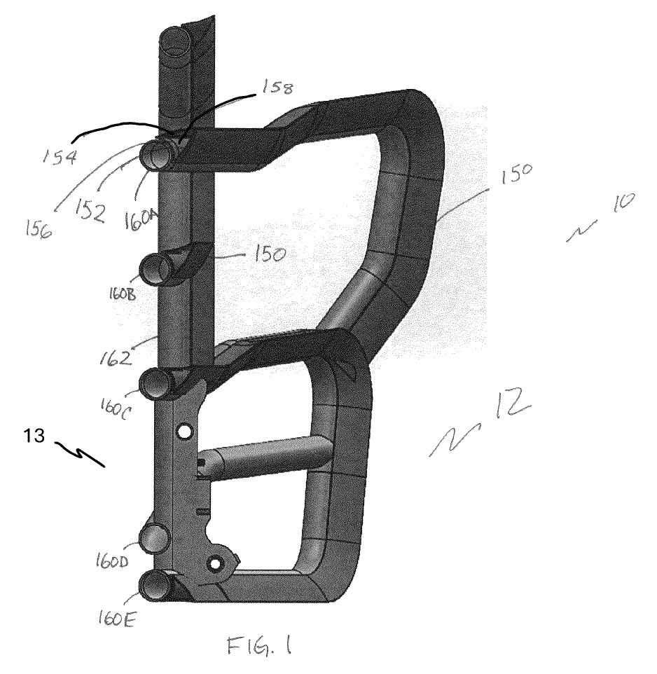

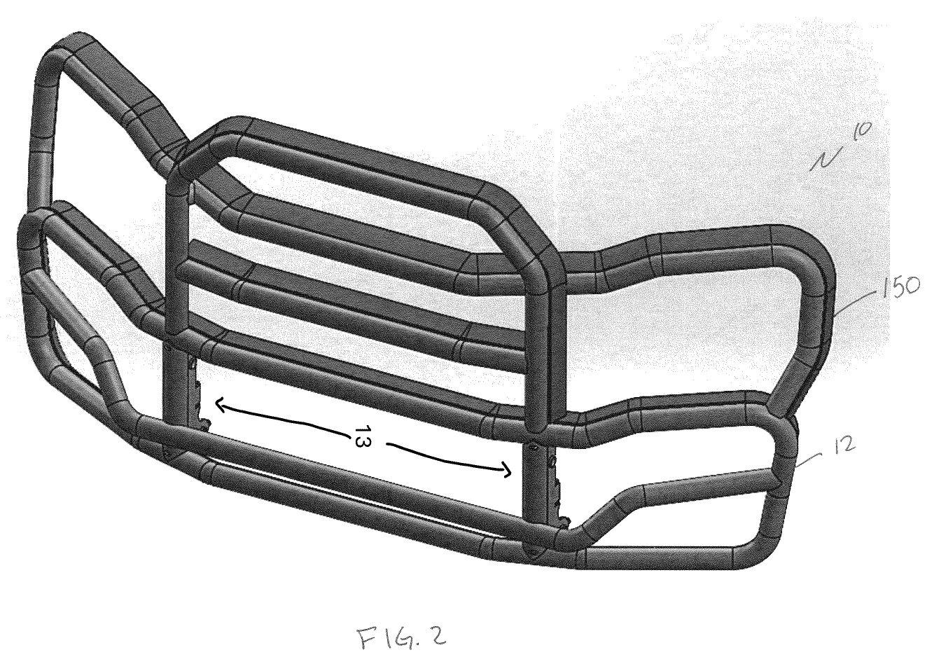

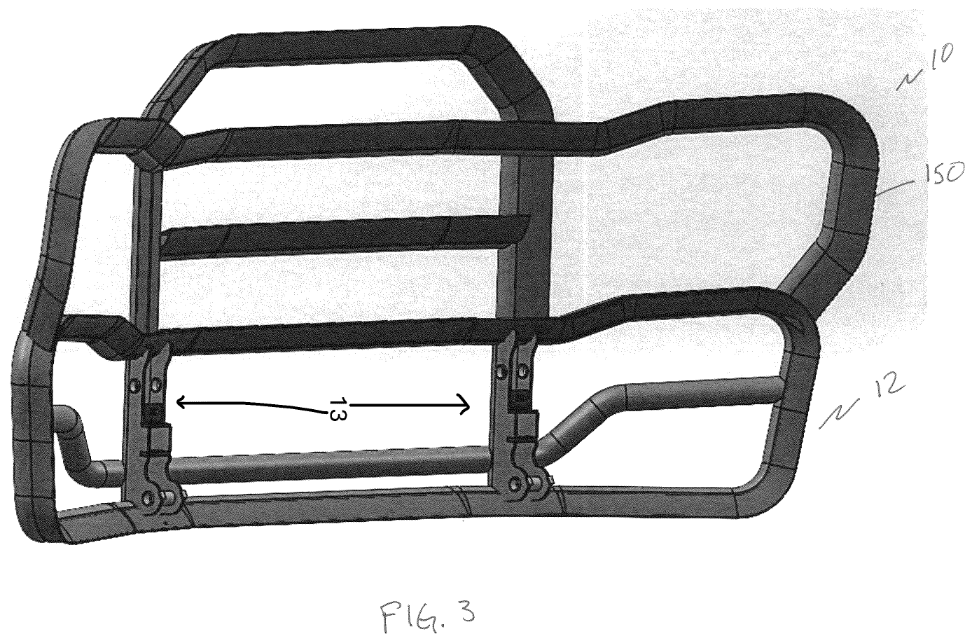

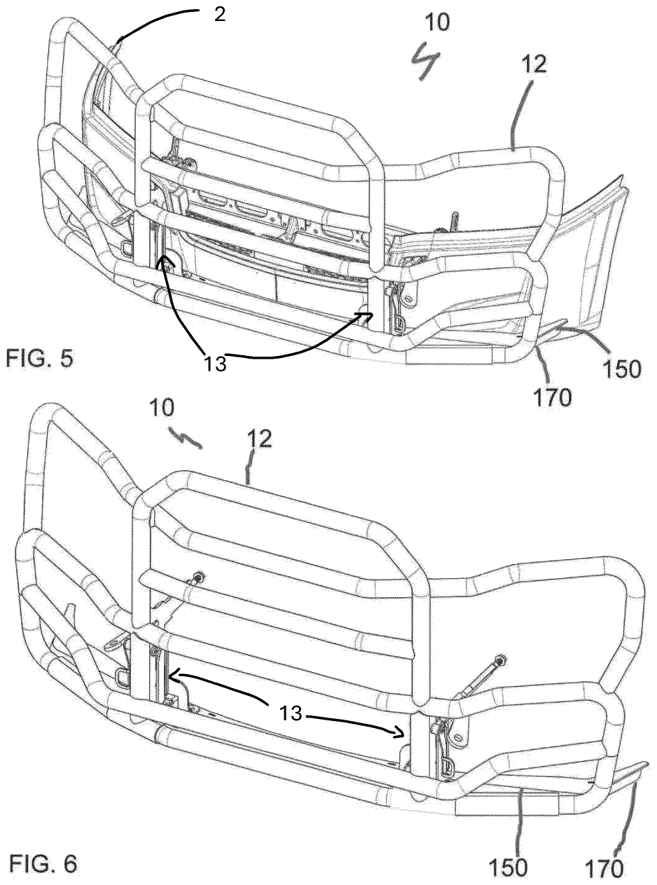

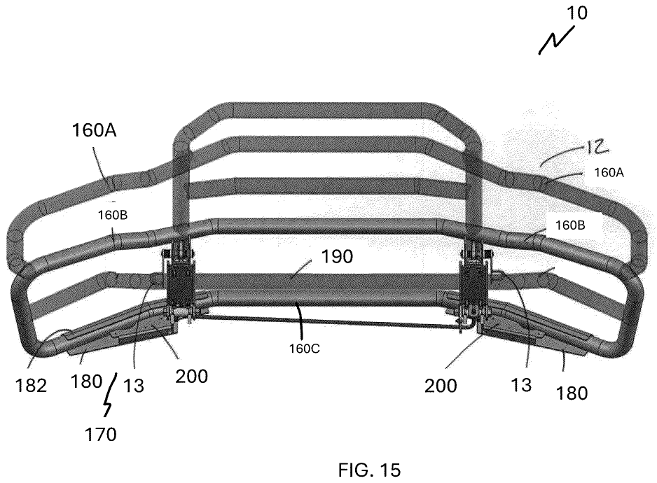

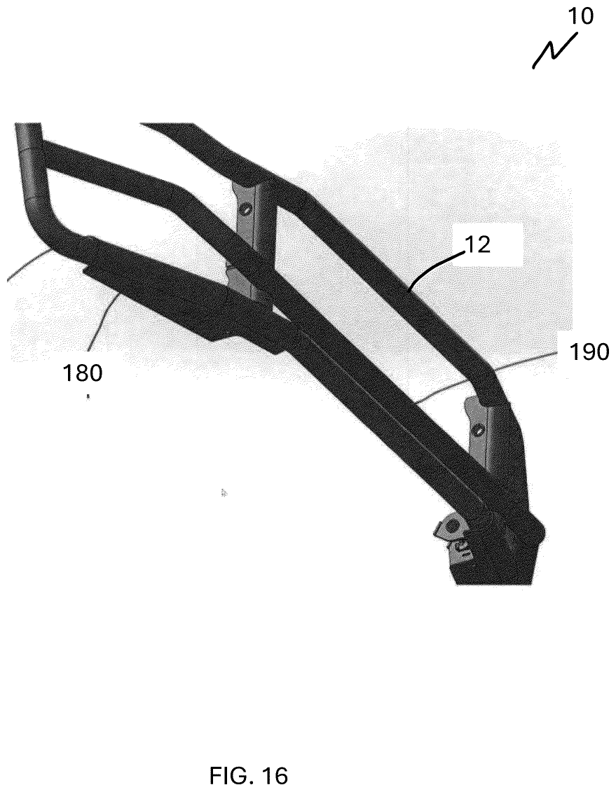

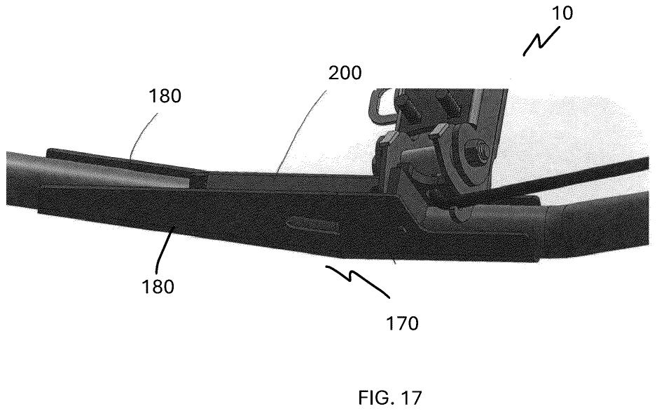

Turning to the figures in greater detail, various exemplary implementations of a grille guard 10 are depicted in FIGS. 1-18 and the attached application.

As is shown in FIGS. 1-18, the various implementations of the, optionally quick release, grille guard 10 comprise a grille guard assembly 12 and latching system 13, as has been previously described in the incorporated references. It would be readily appreciated, that for the implementations described herein, the quick release latching system 13 is optional, and that the implementations relating to the aerodynamic features discussed below can also be applied to any sort of guard or other feature mounted to the front end of a vehicle, as would be readily appreciated by those of skill in the art.

In the implementations of FIGS. 1-3, the assembly 12 further comprises one or more aerodynamic features, shown generally at 150, affixed to or otherwise integrated into the various components of the assembly 12, such as the crossbars 160A, 160B, 160C, 160D, 160E and other components (shown generally at a vertical bar 162), as would be readily appreciated.

In certain of these implementations, the aerodynamic features 150 can be modular pieces 150 that are affixed to the crossbars 160A, 160B, 160C, 160D, 160E and other assembly 12 components via an adhesive or other physical or chemical attachment systems, such as snap-fit or via fasteners and the like, as would be readily appreciated. In various implementations, these aerodynamic features 150 are designed to be purchased as an after-market product and configured to be installed on an existing grille guard or other front-mounted accessory for a vehicle. That is, in certain of these implementations, a vehicle may be mounted with a grille guard of any of a number of possible brands, and the aerodynamic features 150 are constructed and to specifically attach to each of these possible brands as an aftermarket product.

In alternate implementations, the aerodynamic features 150 are not modular and are instead physical projections emerging from the crossbars 160A, 160B, 160C, 160D, 160E and other features of the guard assembly 12.

In various implementations, the aerodynamic features 150 can be fairings or air flow diverters 150 that are generally triangular or fin-shaped, having sides 152, 154, 156 and defining a central opening 158. In implementations wherein the aero features 150 are directly implemented into the crossbars 160A, 160B, 160C, 160D, 160E and other features, there may not be an internal side 156, and the opening 158 is coextensive with the interior of the specific crossbar and aero feature 150, as would be understood.

It is understood that in these implementations, the various sides 152, 154, 156 may be optionally curved so as to best fit to the crossbars 160A, 160B, 160C, 160D, 160E and other features (as is shown at the internal side 156) as well as to direct the flow of air over the external sides 154, 156—such as a top side 154 and a bottom side 156—in the desired direction.

For example, in various implementations, the desired direction of air flow at an upper crossbar 160A may be upward, while the desired direction of air flow at a lower crossbar 160E may be downward, as would be understood. In various implementations, the optional curvature of the sides exterior sides 152, 154 is also calibrated to optimize airflow and reduce drag on the quick release grille guard 10 so as to minimize or eliminate the overall energy usage of the supporting vehicle and result in a reduced or eliminated environmental impact caused by the use of the quick release grille guard 10. It is appreciated that different configurations and air flow directions/angles may be utilized depending on the make and model of the particular vehicle that the guard 10 is being fitted to, and that a variety of angles, shapes and directions are of course contemplated.

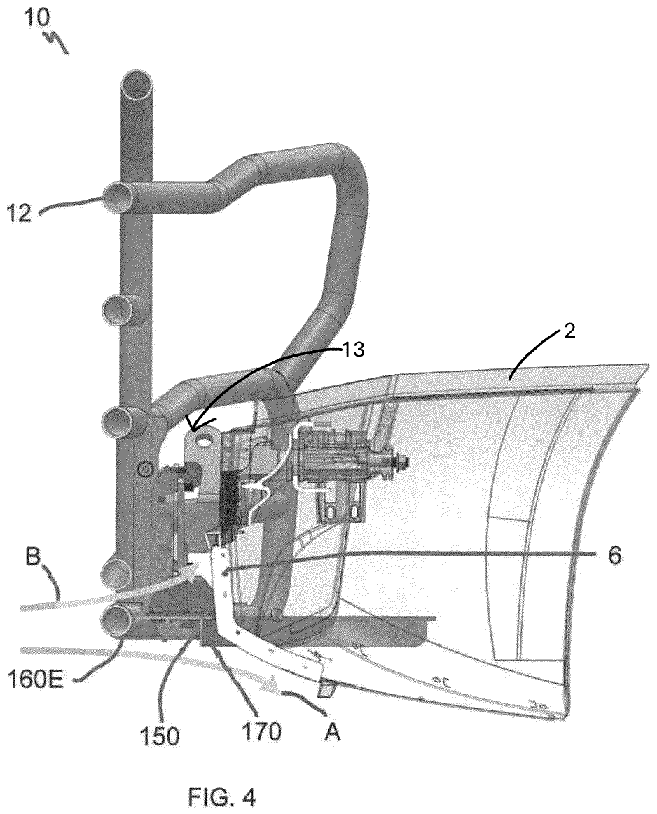

FIGS. 4-11 depict a further optional aerodynamic feature 150 being a plate/shelf/extension 170 or other device shaped and arranged to seal the gap between the guard 12, optionally the lower cross bar 160E, and the bumper 6/front end of the vehicle 2. By closing/sealing the gap between the guard 12 and the bumper 6 air flow is separated and directed below the guard 12/vehicle 2 following arrow A and above the lower crossbar 160E following arrow B. By separating and diverting the airflow, turbulent airflow behind the guard 12 is minimized thereby improving the aerodynamics of the vehicle 2 and guard 12 combination.

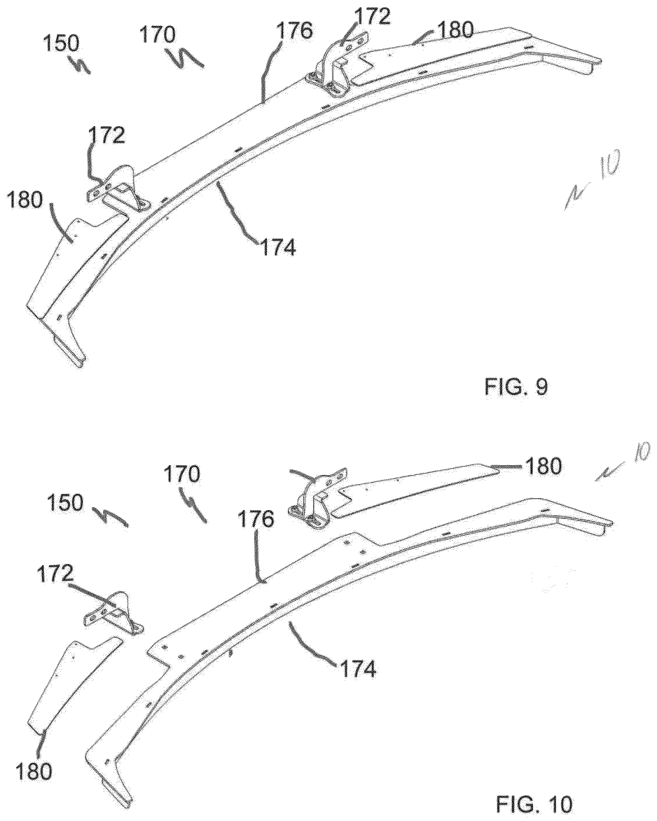

Shown for example in FIGS. 9 and 10, in various implementations, the plate 170 includes one or more brackets 172 configured to affix the plate 170 to the guard 12 via one or more fasteners, as would be understood. In further implementations, the plate 170 may be affixed to the guard 12 via adhesive or any other known and appreciated method or device. In certain further implementations, the plate 170 may be integrated into/formed with the guard 12.

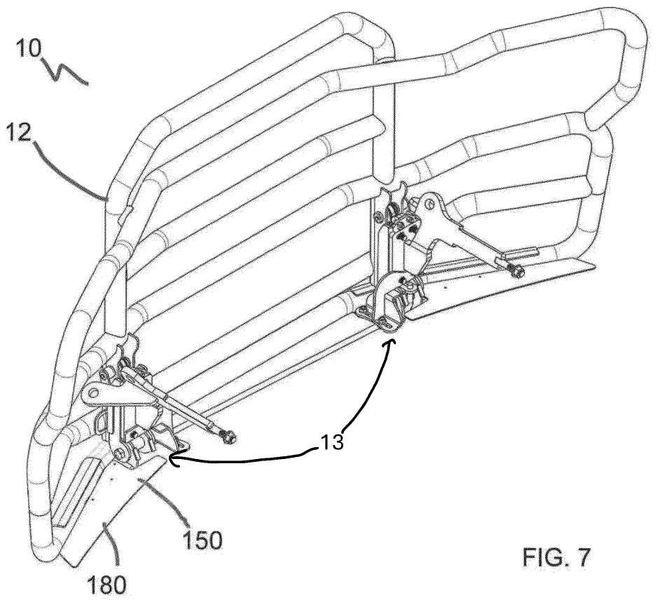

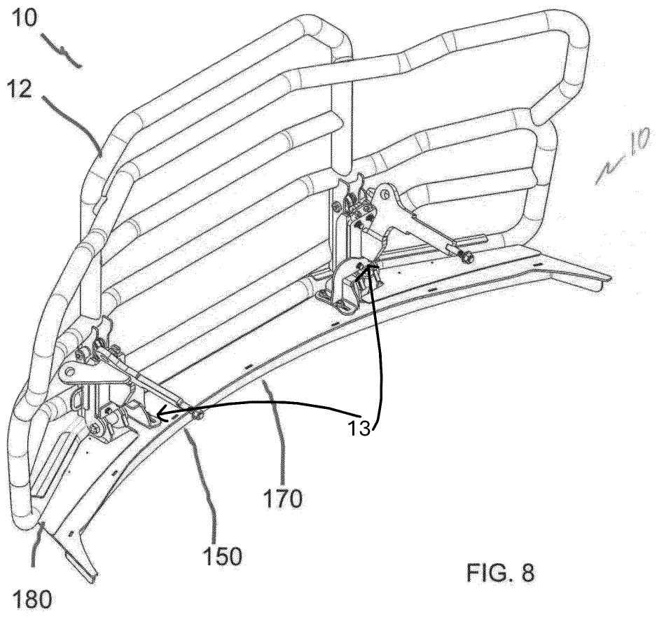

In certain further implementations, the aerodynamic feature 150 includes wings 180, shown variously in FIGS. 7-10. The wings 180 may be bolted, riveted, or otherwise affixed to the guard 12 such that when the guard 12 is in the upright position the wings 12 are adjacent to/nested next to the plate 170 to fill the entire gap between the guard 12 and the vehicle 2. In various implementations, such wings 180 are needed to allow for the necessary clearance to allow for movement of the guard 12 into a folded down position as has been previously described.

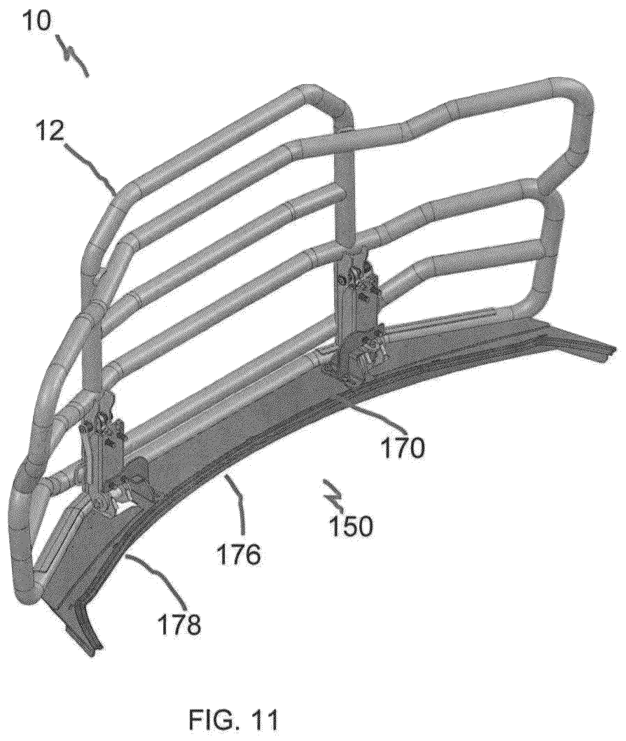

In certain implementations, the plate 170 includes one side 174 shaped to follow the contour of the front end of the vehicle 2, in order to seal the gap between the guard 12 and the vehicle 2. Optionally, the side 174 also includes a gasket 178 (shown for example in FIG. 11). The gasket 178 acting to further seal the plate 170 against the vehicle 2, while not causing damage to the vehicle 2.

The plate 170 may further include a second side 176 shaped to follow the contours of the guard 12, which may generally follow the curvature of the front end of the vehicle 2. Such curvature will vary between vehicle types, makes, and models, as would be generally understood.

In certain implementations, shown for example in FIG. 10, the plate 170 may be modular. That is, the plate 170 may be comprised of two, three, or more individual pieces that may be joined via fasteners, welding, or other methods to form the plate 170.

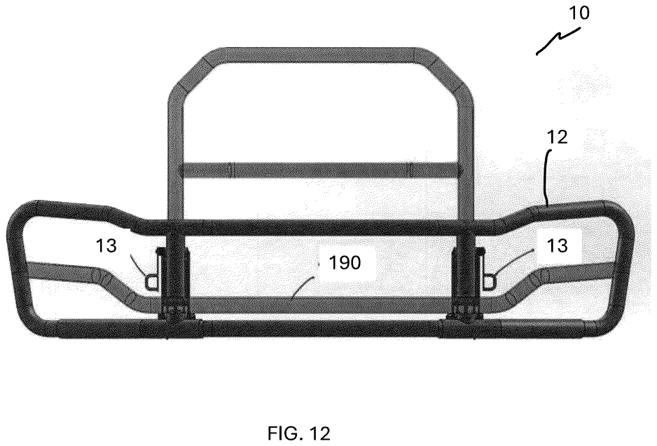

FIGS. 12-18 further illustrate several aspects of the disclosed assembly 10 according to certain implementations, wherein the assembly 10 further comprises support features and further reinforcements and configurations designed to prevent damage to the front end of the vehicle and additional damage mitigation. In these implementations, the assembly 10 and/or guard 12 features additional features for prevention of certain damage to the front end of the vehicle and other bad outcomes resulting from a collision.

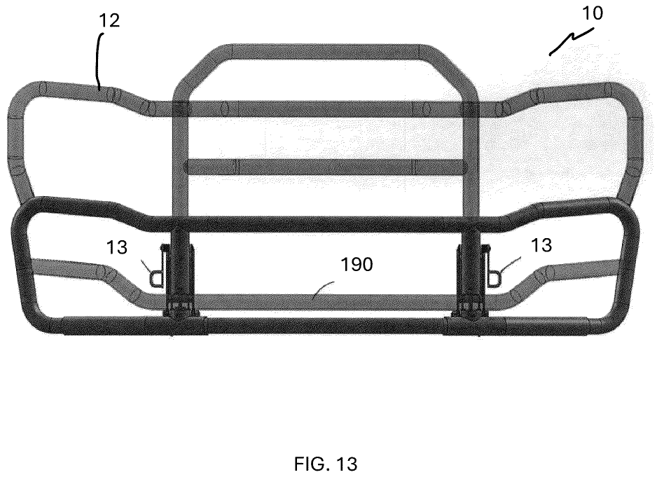

In certain of these implementations, and as shown in FIGS. 12-13, the assembly 10 features an added front end protection bar 190 that extends over critical front end components of a vehicle, such as a modern truck. This is referred to herein as a front end protection bar 190, and it provides additional protection over those critical front end components, such as collision mitigation systems and foglamps, among others. The front end protect bar 190 may be comprised on the same material as the grille guard, such as high-tensile steel tubing and PVC coating.

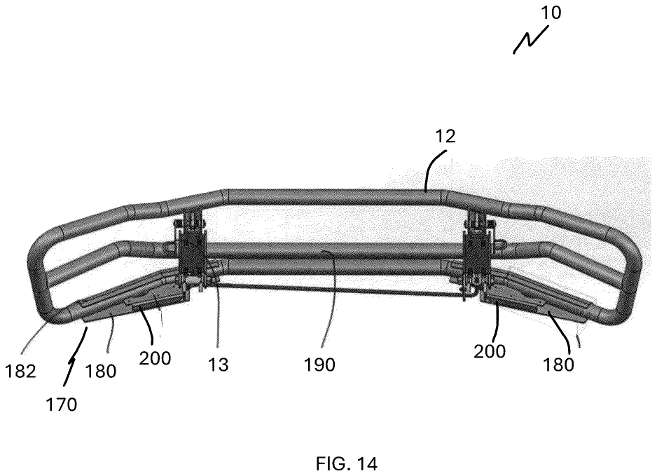

Further, in various implementations of the guard 10, and as shown in FIGS. 14-18, includes wings 180 which optionally wrap around the guard 12 with support wraps 182 and further comprise gusseting 200 configured to additional provide additional strength against compression to provide a front underrun mitigation system and further support against damage to the front tires.

The gusseting 200 may be fame from plate steel, to withstand major impact not only from head-on impacts but from various angles as well.

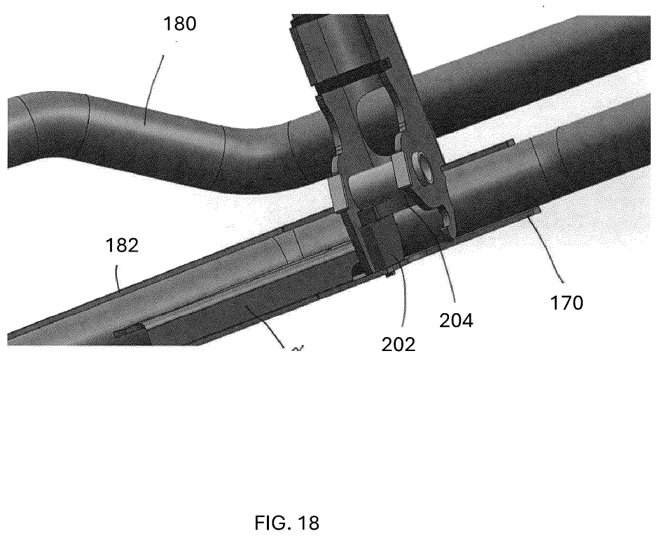

In various of these implementations, the gusseting 200 is bolstered by certain transfer members 202, 204 (shown in FIG. 18) that are configured to transfer energy from the front of the guard to the gusseting 200 and dissipate the energy laterally, as would be appreciated. These systems and gusseting 200 are referred to below as a Front Underrun Mitigation System, and are designed to comply with UN ECE R93, an internationally recognized benchmark for front underrun protection. In certain further implementations, the disclosed assembly 10 is configured as a bolt-on front underrun protection device dimensioned and arranged to satisfy the performance requirements of UN ECE R93 when installed on a truck.

In certain implementations, a mounting bracket/latching system 13 comprises a pair of bracket members adapted to engage the OEM tow hooks of the vehicle so as to enable installation without modification to OEM structural elements. In further implementations, the mounting bracket system 13 comprises a clamp or receiver assembly configured to fit multiple OEM tow hook geometries across different makes and models. In such arrangements, collision forces are transferred into the tow-hook supported frame structures, thereby enhancing robustness and promoting compliance with UN ECE R93 front underrun protection benchmarks.

In further implementations, the guard 10 frame 12 is configurable in multiple height variations. In a first configuration, the guard 12 extends from a tow hook region downward to a height not greater than the minimum height required by UN ECE R93 so as to provide underrun protection with minimal frontal coverage. In a second configuration, the grille guard 12 extends upward to provide additional coverage of grille and headlamp regions while maintaining the same lower geometry and energy transfer pathways necessary for underrun compliance (compare FIGS. 12 and 13). In a third configuration, the guard 12 incorporates additional lateral or vertical members so as to provide enhanced steer tire protection and protection of collision mitigation sensors, lamps and associated components.

In certain implementations, the grille guard 12 is pivotably mounted and includes quick release latching system 13 to allow opening for engine access while maintaining repeatable and secure positional control in the closed position. In such implementations, lift assistance features may be incorporated so as to maintain an operator effort below a predetermined threshold, such as less than approximately five pounds, while preserving structural integrity and compliance characteristics during impact events.

In further implementations, the guard 10 frame 12 is positioned forward of the bumper while remaining outside of the encroachment zone of a collision mitigation sensor located in or proximate the bumper. In such implementations, the guard 12 geometry is arranged to avoid obstruction, interference, or false triggering of radar-based or camera-based collision mitigation systems, while still providing underrun protection and tire protection. Clearance envelopes and positional tolerances are established so as to ensure proper sensor operation across production and installation variation. Sensor offsets are discussed in certain of the incorporated references.

In certain implementations, the guard 10 frame 12 comprises tubular members of high-tensile steel with a corrosion-resistant coating, such as a PVC coating, as has been previously discussed. The tubular construction is dimensioned and reinforced to satisfy UN ECE R93 underrun protection requirements while providing a lighter weight alternative to a full bumper replacement. In some arrangements, the tubular members are reinforced with welded gusset plates 180, 200 and transfer members 202, 204 to distribute head-on and angled impact loads into the brackets 13 and vehicle 2 structure in a controlled manner.

In various implementations, the guard assembly 10 is provided as a retrofit kit comprising a guard frame 12 configured to extend across the forward portion of the vehicle, a pair of mounting brackets (as part of the mounting/latching system 12) configured to engage OEM tow hooks, and one or more reinforcement plates 170 or beams 190. In certain implementations, at least one reinforcement plate 180 extends laterally across the truck at a height less than approximately 445 mm from the ground so as to meet R93 geometric criteria while preserving ground clearance and approach angle as would be appreciated.

In further implementations, the guard assembly 10 includes a steer tire protection system, which comprises forwardly positioned tubular members 160A, 160B, 160C, 190 and gusseting 200 configured to resist incursions into the steer tire envelope during head-on and angled impacts. In such implementations, the steer tire protection system is integrated with the front underrun mitigation system so as to simultaneously protect the steer tires and satisfy international underrun protection criteria. In certain implementation, the steer tire protection system is implemented with rearward strength gusseting 200 behind lower members 160C and a lower protective bar 160C positioned to intercept objects that might otherwise enter the steer tire zone.

In certain implementations, as shown for example in FIGS. 12-18, the assembly 10 further comprises a front end protection bar 190 arranged to provide additional reinforcement and protection around collision mitigation sensors, fog lamps, and other forward vehicle components, as discussed above. The front end protection bar 190 may be formed from the same high-tensile tubular steel as the guard frame and coated to resist environmental degradation. The front end protection bar 190 may be integrated with the lower crossbar 160C geometry and gusseting 200 so as to contribute to underrun performance and load distribution during impact events.

In further implementations, the disclosed devices and systems are integrated in combination with the R93-compliant geometry so as to reduce fuel consumption impact associated with guard 10 use. In these implementations, fairings, shelves, and sealing plates are arranged to manage airflow around and through the tubular structure 12, while maintaining sensor clearance envelopes and without introducing disruptive reflections or occlusions for radar or camera systems.

In further implementations, the modular nature of the brackets (as part of the latching/mounting system 12), clamp receivers, reinforcement plates 170, and tubular members 160A-E, 190, enables compatibility with a variety of truck models without permanent modification to OEM bumpers, frames, or tow hook structures. The systems are thus serviceable and upgradable in the field, allowing fleets to select variable height coverage levels, add or remove front end protection bars 190, or adjust features while preserving the validated underrun protection capability.

Materials and coatings for the tubular members 160A-E, 190 and plates 170, 180 may include high-tensile steel and polymeric coatings configured to provide long-term corrosion resistance and impact durability. In certain implementations, a PVC-based coating provides a thickness sufficient to absorb minor impacts and return to shape, while also resisting UV, cracking, peeling, and flaking over extended service life. In other implementations, alternative corrosion-resistant coatings or treatments may be employed while maintaining the weight and performance characteristics necessary to meet R93 requirements.

The disclosed systems and methods therefore provide a grille guard assembly 10 that integrates quick-release serviceability, steer tire protection, and global underrun protection benchmarks in a tubular, lighter-weight configuration that can be retrofitted via OEM tow hooks. These features can be applied individually or in combination on new or existing vehicles and can be adapted to the particular frontal geometry, sensor placement, and operational requirements of a given fleet.

The guard 10 may additionally include rattle resistant latches, such as the cam latching systems described in U.S. patent application Ser. No. 19/182,309.

In various implementations, any of these support features can be retrofitted onto existing guards, and all of the guard 12 components are optional.

### A. Testing

Three test articles were tested for the Front Underride Protection system testing. Each were impacted by a hydraulic press up to a specified percentage of the maximum weight of the vehicle at varying locations (P1, P2 & P3) for at least 0.2 s. P1 is located 200 mm from outermost points of the tire and was to experience a load 50% of the weight (~18,000 lbs); P2's location is symmetric about the median longitudinal plane at a distance of 700-1200 mm apart, ultimately being specified by the manufacturer, and experienced a load of 100% of the weight; P3 is located at the vertical longitudinal median plane of the vehicle and experienced a load of 50% of the weight. The maximum ground clearance was under 400 mm and the maximum height of the load that was applied was under 445 mm.

The impact event is to be documented by two High Speed cameras and one Real Time camera. The testing apparatus was instrumented in the following manner: 2 X-Axis Load Cells; String Potentiometer; and Temposonics MDT (Linear Position Sensor).

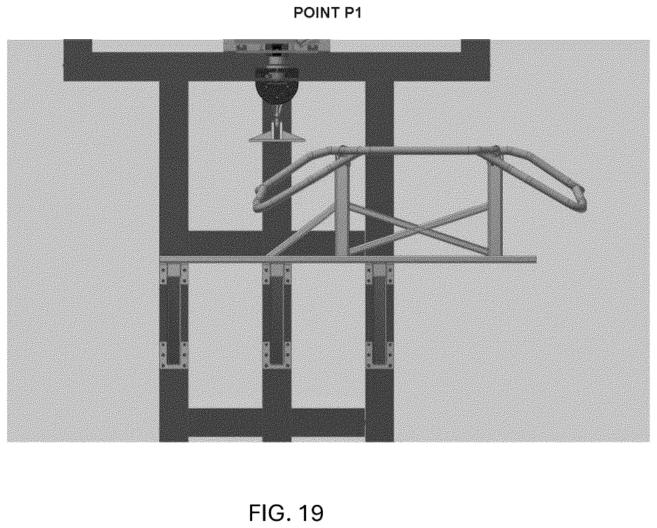

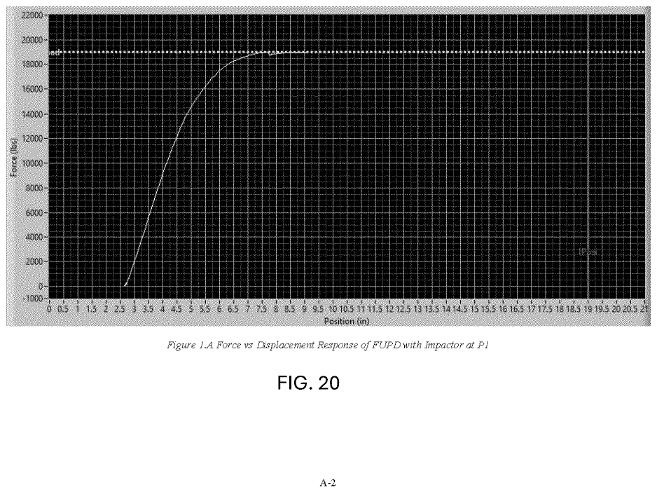

FIG. 19 shows a test diagram for a first test of application of force at point P1. From observation, the load reached the required load. The deformation did not reach the 400 mm max after the load was released from the test article. FIG. 20 shows a force versus displacement chart for response of FUPD with Impactor at P1.

TABLE 1
Beam Attitudes

| | Units | Left Corner | Center | Right Corner |
|---|---|---|---|---|
| As Tested | mm | 360 | 361 | 360 |

TABLE 2
Attitude Application of Force

| | Units | Height of Force |
|---|---|---|
| As Tested | mm | 404 |

*Attitudes are taken from the ground to the bottom edge of the beam once installed onto the mounting fixture

TABLE 3
Distance from P1 to Centerline

| | Units | Distance |
|---|---|---|
| As Tested | mm | 999 |

TABLE 4
Beam Attitudes

| | Units | Left Corner | Center | Right Corner |
|---|---|---|---|---|
| Post Test | mm | 363 | 361 | 360 |

TABLE 5
Plastic Deformation of Beam

| | Units | Deformation |
|---|---|---|
| Pre-Test | mm | 204 |
| Post Test | mm | 324 |
| Delta (Pre-Post) | mm | 120 (<400) |

TABLE 6
Highest Force Recorded

| | Units | Force |
|---|---|---|
| As Tested | lb | 19,000 |

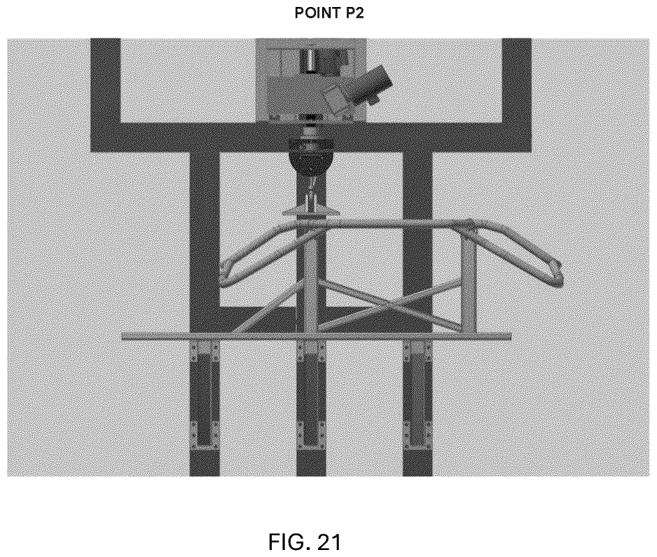

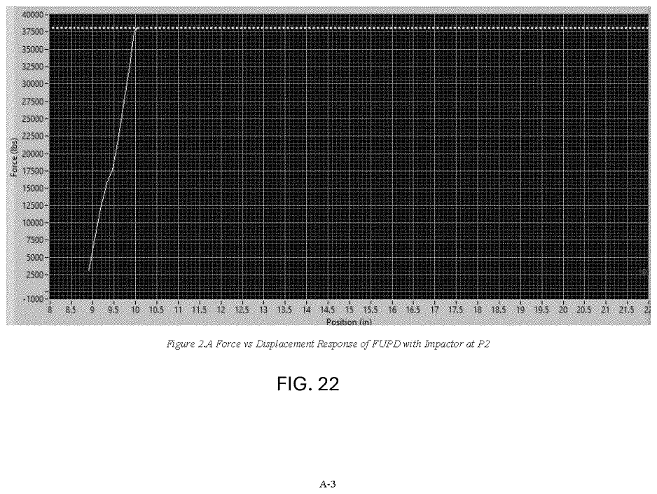

FIG. 21 shows a test diagram for a first test of application of force at point P2. From observation, the load reached the required load. The deformation did not reach the 400 mm max after the load was released from the test article. FIG. 22 shows a force versus displacement chart for response of FUPD with Impactor at P2.

TABLE 7
Beam Attitudes

| | Units | Left Corner | Center | Right Corner |
|---|---|---|---|---|
| As Tested | mm | 363 | 360 | 360 |

TABLE 8
Attitude Application of Force

| | Units | Height of Force |
|---|---|---|
| As Tested | mm | 402 |

*Attitudes are taken from the ground to the bottom edge of the beam once installed onto the mounting fixture

TABLE 9
Distance from P2 to Centerline

| | Units | Distance |
|---|---|---|
| As Tested | mm | 545 |

TABLE 10
Beam Attitudes

| | Units | Left Corner | Center | Right Corner |
|---|---|---|---|---|
| Post Test | mm | 363 | 360 | 360 |

TABLE 11
Plastic Deformation of Beam

| | Units | Deformation |
|---|---|---|
| Pre-Test | mm | 0 |
| Post Test | mm | 18 |
| Delta (Pre-Post) | mm | 18 (<400) |

TABLE 12
Highest Force Recorded

| | Units | Force |
|---|---|---|
| As Tested | lb | 38,000 |

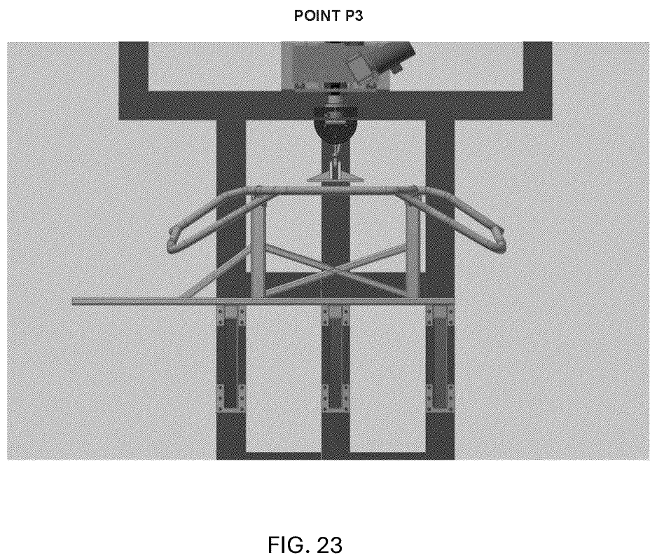

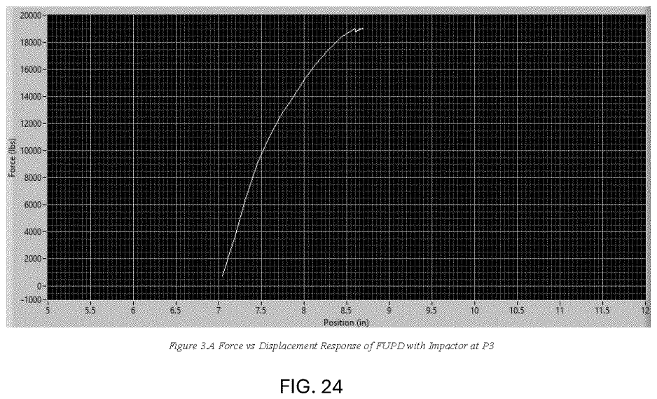

FIG. 23 shows a test diagram for a first test of application of force at point P3. From observation, the load reached the required load. The deformation did not reach the 400 mm max after the load was released from the test article. FIG. 24 shows a force versus displacement chart for response of FUPD with Impactor at P3.

TABLE 13
Beam Attitudes

| | Units | Left Corner | Center | Right Corner |
|---|---|---|---|---|
| As Tested | mm | 363 | 360 | 361 |

TABLE 14
Attitude Application of Force

| | Units | Height of Force |
|---|---|---|
| As Tested | mm | 402 |

*Attitudes are taken from the ground to the bottom edge of the beam once installed onto the mounting fixture

TABLE 15
Distance from P2 to Centerline

| | Units | Distance |
|---|---|---|
| As Tested | mm | 0 |

TABLE 16
Beam Attitudes

| | Units | Left Corner | Center | Right Corner |
|---|---|---|---|---|
| Post Test | mm | 363 | 360 | 360 |

TABLE 17
Plastic Deformation of Beam

| | Units | Deformation |
|---|---|---|
| Pre-Test | mm | 0 |
| Post Test | mm | 26 |
| Delta (Pre-Post) | mm | 26 (<400) |

TABLE 18
Highest Force Recorded

| | Units | Force |
|---|---|---|
| As Tested | lb | 19,000 |

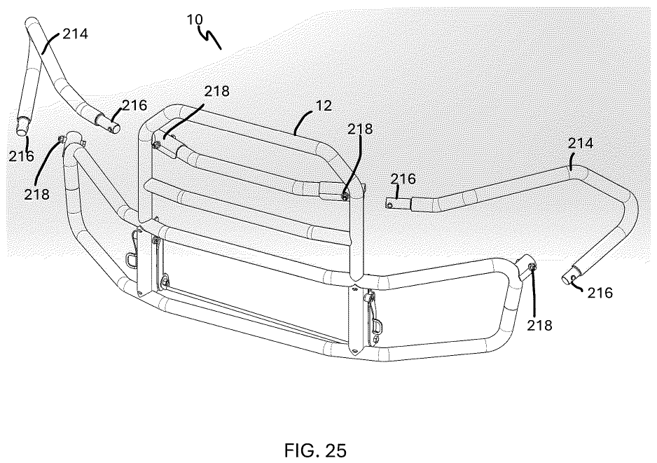

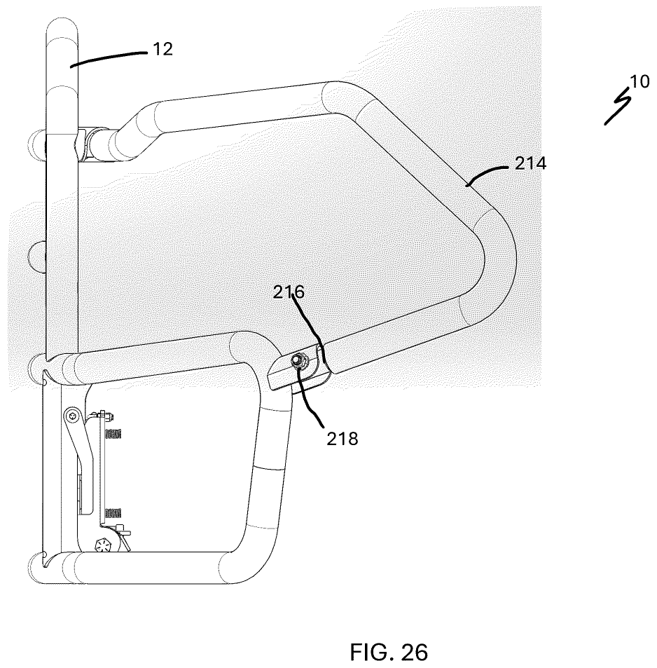

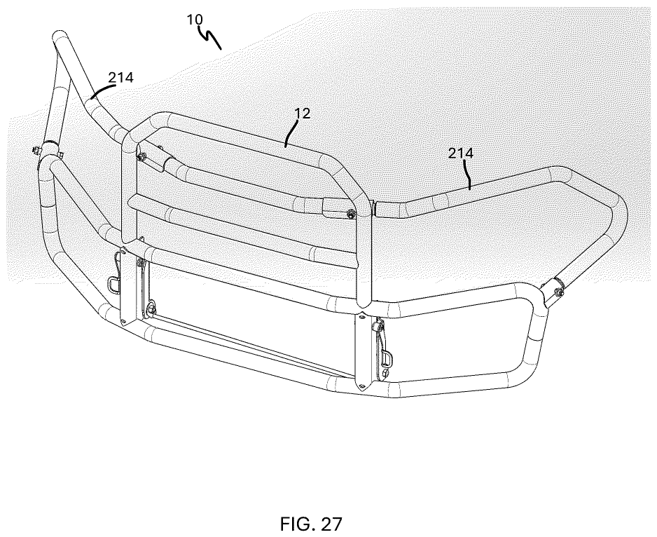

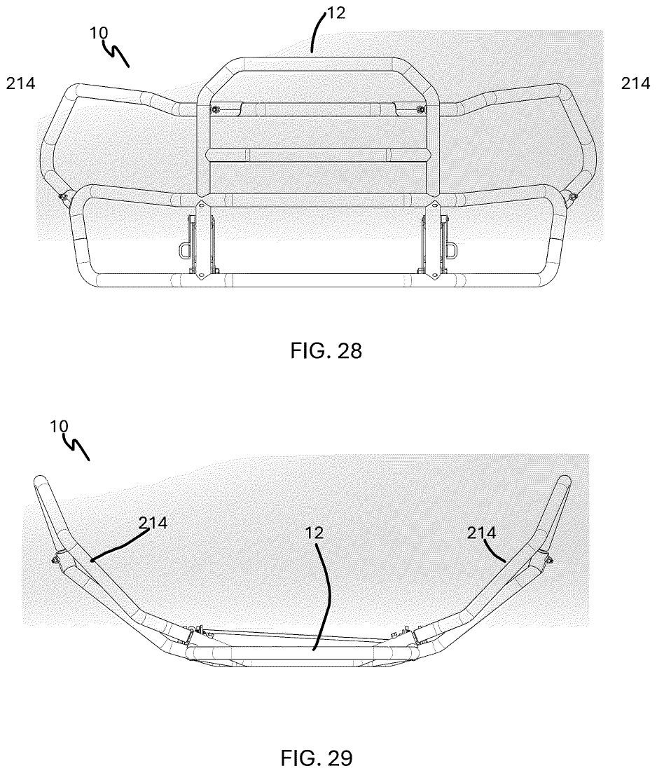

In certain implementations, the guard 10 may be modular include removable loupes 214, shown in FIG. 25. That is, one or more of the loupes 214 may be selectively removable from the body 12 of the guard 10. The loupes 214 may optionally be configured to surround the headlights of the vehicle when the guard 10 is mounted to a front end of the vehicle and in the upright position, as would be understood.

In these implementations, the loupes 214 may be include a male end 216 configured to be fitted into a female end 218 on the body 12 of the guard 10. The opposite is also possible. The ends 214, 216 may include a pin and corresponding opening in which the pin may be inserted or extend through as would be understood to affix the loupes 214 to the body 12 of the guard 10. Various additional attachment mechanisms are possible and would be understood by those of skill in the art.

The loups 214 may be removable for ease of transportation (shipping) and storage. Additionally, the loupes 214 may be removable for replacement should they become damaged.

Although the disclosure has been described with references to various embodiments, persons skilled in the art will recognize that changes may be made in form and detail without departing from the spirit and scope of this disclosure.

What is claimed is:

1. An apparatus comprising a grille guard assembly configured for installation on a front end of a vehicle, the grille guard assembly comprising:
(a) a frame having a plurality of tubular crossbars and
(b) at least one aerodynamic feature affixed to or integrated with at least one of the tubular crossbars,
wherein the aerodynamic feature is shaped to direct airflow in a desired direction so as to reduce aerodynamic drag associated with the grille guard assembly during vehicle operation.

2. The apparatus of claim 1, wherein the aerodynamic feature comprises a fairing or airflow diverter having a generally triangular or fin-shaped profile with sides defining a central opening, the sides including a top side and a bottom side contoured to direct airflow in the desired direction.

3. The apparatus of claim 1, wherein the aerodynamic feature is a modular component configured to be affixed to an existing grille guard via an adhesive, snap-fit interface, or fasteners.

4. The apparatus of claim 1, wherein the aerodynamic feature is integrated into a tubular crossbar such that an internal side of the feature is coextensive with an interior of the tubular crossbar.

5. The apparatus of claim 1, wherein curvature of exterior surfaces of the aerodynamic feature is selected to direct airflow upward at an upper crossbar and downward at a lower crossbar to reduce drag on the grille guard assembly.

6. The apparatus of claim 1, further comprising a quick-release latching system pivotably mounting the grille guard assembly to the vehicle.

7. The apparatus of claim 1, wherein the frame comprises high-tensile steel tubular members coated with a corrosion-resistant polyvinyl chloride coating.

8. The apparatus of claim 1, further comprising a front end protection bar extending over forward vehicle components including collision mitigation sensors and lamps.

9. A front underrun protection system configured as a bolt-on assembly mountable to a vehicle via one or more brackets, the system comprising:
(a) a tubular guard frame comprising at least a lower crossbar;
(b) gusseting positioned to resist compression; and
(c) transfer members arranged to transfer impact energy laterally into the gusseting.

10. The device of claim 9, wherein the gusseting comprises welded plate gussets arranged behind the lower crossbar.

11. The device of claim 9, wherein the tubular frame is arranged in multiple selectable height configurations.

12. The device of claim 9, wherein the frame and gusseting are configured to distribute head-on and angled impact loads into the one or more brackets and the vehicle in a controlled manner while remaining forward of a bumper-mounted collision mitigation sensor and outside of a sensor encroachment zone.

13. The device of claim 9, further comprising a front end protection bar integrated with the lower crossbar and gusseting.

14. A vehicle front-end aerodynamic sealing system comprising a plate arranged to close a gap between a grille guard and a front bumper of a vehicle, the plate being contoured to the front end of the vehicle and configured to separate airflow above and below a lower crossbar of the grille guard in order to reduce turbulence behind the grille guard during vehicle operation.

15. The system of claim 14, wherein the plate comprises brackets configured to affix the plate to the grille guard using fasteners.

16. The system of claim 14, wherein the plate includes a gasket along a first side contoured to the vehicle front end to seal against the vehicle.

17. The system of claim 14, wherein the plate is modular and comprises multiple pieces that are joinable by fasteners or welding.

18. The system of claim 14, further comprising wings affixed to the grille guard and arranged to nest adjacent to the plate in an upright position to fill a gap between the grille guard and the vehicle while providing clearance for folding movement of the grille guard.

19. A grille guard assembly for a vehicle, comprising:
(a) a guard frame comprising a plurality of tubular members;
(b) a mounting and latching system configured to couple the guard frame to the vehicle; and
(c) a front underrun mitigation structure integrated with the guard frame and comprising:
(i) a lower cross member;
(ii) gusseting; and
(iii) at least one transfer member arranged to route impact loads into the mounting and latching system and laterally across the guard frame.

20. The grille guard assembly of claim 19, wherein the mounting and latching system comprises a pair of bracket members adapted to engage tow hooks of the vehicle.

21. The grille guard assembly of claim 19, wherein the gusseting comprises plate steel gusset plates welded to the tubular members.

22. The grille guard assembly of claim 19, wherein the at least one transfer member is located rearward of the lower cross member and is oriented to dissipate impact energy laterally into the gusseting and toward the mounting and latching system.

23. The grille guard assembly of claim 19, further comprising a front end protection bar extending across a forward region of the vehicle to overlie at least one of a collision mitigation sensor, a fog lamp, or another forward component.

24. The grille guard assembly of claim 19, wherein the guard frame includes wings that wrap around lateral portions of the vehicle front end and include support wraps and gusseting.

25. The grille guard assembly of claim 19, wherein the guard frame is positioned forward of the vehicle bumper while remaining outside a sensor encroachment zone of a radar- or camera-based collision mitigation system located in or proximate the bumper.

26. The grille guard assembly of claim 25, wherein the guard frame geometry defines clearance envelopes and positional tolerances that avoid obstruction, interference, or false triggering of the collision mitigation system across production and installation variation.

27. The grille guard assembly of claim 19, wherein the tubular members comprise high-tensile steel with a corrosion-resistant coating.

28. The grille guard assembly of claim 19, further comprising a steer-tire protection system integrated with the front underrun mitigation structure and including forwardly positioned tubular members and rearward gusseting behind the lower cross member to resist incursions into a steer-tire envelope during head-on and angled impacts.

29. The grille guard assembly of claim 19, further comprising one or more of aerodynamic fairings, shelves, or sealing plates arranged to manage airflow around and through the tubular members.
